(19) United States
(12) Patent Application Publication
(10) Pub. No.: US 2023/0191771 A1
(43) Pub. Date: Jun. 22, 2023

(54) A MACHINE FOR SURFACE TREATMENT OF A FILM

(71) Applicant: MuCell Extrusion, LLC, Woburn, MA (US)

(72) Inventor: Torben Andersen, Stilling, Skanderborg (DK)

(73) Assignee: MuCell Extrusion, LLC, Woburn, MA (US)

(21) Appl. No.: 17/925,339

(22) PCT Filed: May 14, 2021
(86) PCT No.: PCT/EP2021/062841

§ 371 Date: Nov. 15, 2022

(30) Foreign Application Priority Data
May 15, 2020 (DK) PA202070321

(51) Int. Cl. B41F 15/08; B41M 1/12

(52) U.S. Cl. CPC B41F 15/0836; B41M 1/12

(57) ABSTRACT

A machine (100) for surface treatment of a film (202) is disclosed. The machine (100) includes a surface treatment unit (110) for surface treating at least a portion (204) of the film (202). In addition, the machine (100) includes a template (112) arranged between the surface treatment unit (110) and the film (202). The template (112) includes at least one cut-out (126) exposing the portion (204) of the film (202) to the surface treatment unit (110) for performing the surface treatment. Furthermore, the machine is adapted to displace the film (202) relative to the surface treatment unit (110) during the surface treatment of the film (202).

### TECHNICAL FIELD OF THE INVENTION

The present disclosure generally relates to a machine for facilitating a surface treatment of a film. More specifically, the disclosure relates to a machine having a template including at least one cut-out to facilitate a surface treatment of only a portion of the film that corresponds to a printing area of the film.

### BACKGROUND OF THE INVENTION

Containers can be made from many different types of materials. One common way of manufacturing containers comprises stamping a coated paper blank out of a paper stock and then folding the coated paper blank into a container. One typical container produced in this way is a simple drinking cup, for example a coffee cup. In this type of operation, a sidewall blank and a bottom blank are separately cut-out of a sheet/roll stock. The sidewall blank is then folded around the bottom blank. The bottom blank and the sidewall blank are joined together, typically, via a gluing or a heat welding operation. The side seam on the cup is then sealed and an upper rim portion of the cup is typically rolled to form a stiffer edge.

In many cases, it is desired to apply graphics to the sidewall of the container. This could be for marketing and/or informational purposes. When the sidewall blank is stamped out of the stock material, it is often the case that the sidewall blank is not very suitable for printing as the ink may not properly bind to the surface of the sidewall blank. Therefore, the surface of an entire sheet of stock material is generally subjected to a surface treatment operation, for example, a corona or plasma treatment. However, in certain scenarios, a sidewall blank that is stamped from a corona treated sheet may not properly weld with the bottom blank which is undesirable.

### SUMMARY

A first aspect of the current invention is therefore to provide a machine which is a surface treatment machine for a film.

A second aspect of the current invention is to provide a machine that facilitates the surface treatment of selective portions of the film while leaving other portions untreated to facilitate a welding of the various blanks formed from the treated film.

It should be noted that according to the current specification, the term “surface treatment” should be understood as a treatment which directly alters the surface of the film to improve its wetting ability. This is done by increasing the surface energy of the surface of the film. The wetting ability of a surface is typically measured in Dyne/cm. It could therefore be said that the surface treatment of the current invention is designed to increase the Dyne/cm measurement of the surface of the film itself.

Currently available processes are corona treatment and plasma treatment. The Corona process works by directing a high frequency discharge at the plastic surface from close-range to disrupt the molecules. The Plasma process works by grafting nitrogen based groups of molecules on the surface of the plastic material. Both processes increase the surface energy of the surface of the material to give the material better wetting properties. Additional processes which are suitable to increase the surface energy of the surface could be developed in the future and the scope of the current claims should also cover these future surface treatment processes.

It should also be noted that in the prior art, machines are available to apply different types of surface coatings to a film, for example a cloth film. However, the types of machines which apply a surface coating to a film, are according to the current specification not considered to be machines which provide a surface treatment of the film itself, as these prior art machines do not treat the actual surface of the film, rather they just cover the surface with a coating.

The above mentioned aspects are provided at least in part by a machine according to claim 1. According to claim 1, the machine includes a surface treatment unit for surface treating at least a portion of the film and a template arranged between the film and the surface treatment unit. The template includes at least one cut-out exposing the portion of the film to the surface treatment unit. Further, the machine is adapted to displace the film and the template relative to the surface treatment unit during the surface treatment of the film. In this way, the surface treatment can be applied to the area of the film exposed through the cutout. In this embodiment, the cutout is displaced together with the template.

In one embodiment, the template is an endless template sheet and continuously moves with the film during surface treatment.

In one embodiment, the template comprises multiple cutouts arranged along the displacement direction of the template.

In one embodiment, the distance between the template and the film is less than 2 cm, less than 1 cm or less than 0.5 cm. In one embodiment, one surface of the template abuts a surface of the film to the treated. By placing the template and the film close together, the edge of the treated versus untreated portion can be more precisely defined.

In one embodiment, the machine includes a pair of rollers to move the template sheet relative to the surface treatment unit.

In one embodiment, the template is a hollow roll and is adapted to rotate relative to the surface treatment unit.

In one embodiment, the surface treatment unit is disposed inside the hollow roll.

In one embodiment, the machine includes at least one rolling unit disposed opposite to the hollow roll such that the film is supported between the hollow roll and the at least one rolling unit.

In one embodiment, the hollow roll is a driver roller facilitating the movement of the film relative to the surface treatment unit.

In one embodiment, the surface treatment unit is a corona discharge unit.

In one embodiment, a speed of the template relative to the surface treatment unit is equal to a speed of the film relative to the surface treatment unit.

In one embodiment, the template is a metal plate adapted to reciprocate between a first position and a second position to facilitate the surface treatment of the portion of the film.

In one embodiment, the metal plate is moved in a first direction from the first position to the second position with a speed equal to a speed of the film and is moved in a second direction opposite to the first direction to retract the metal plate to the first position upon reaching the second position.

In one embodiment, the template includes a pair of plates adapted to move between a first position and a second position. One of the pair of plates moves in a first direction from the first position to the second position during the surface treatment of the film, while another of the pair of plates moves in a second direction opposite to the first direction to reach the first position from the second position.

In one embodiment, one of the pair of the plates is adapted to reach the second position when the other of the pair of plates reaches the first position.

### BRIEF DESCRIPTION OF THE DRAWINGS

FIG. 1 illustrates a perspective view of a machine including an endless template sheet as a template of the machine, in accordance with an embodiment of the disclosure;

FIG. 2 illustrates a perspective view of a machine having a template as a single flat plate, in accordance with an embodiment of the disclosure;

FIG. 3 illustrates a perspective view of a machine including a template having a pair of plates, in accordance with an embodiment of the disclosure;

FIG. 4 illustrates a front view of a machine having a hollow roll as a template, in accordance with an embodiment of the disclosure;

FIG. 5 illustrates a perspective view of the machine of FIG. 4, in accordance with an embodiment of the disclosure; and

FIG. 6 illustrates an exemplary surface treated film obtained after surface treatment of a film, in accordance with an embodiment of the disclosure.

### DETAILED DESCRIPTION

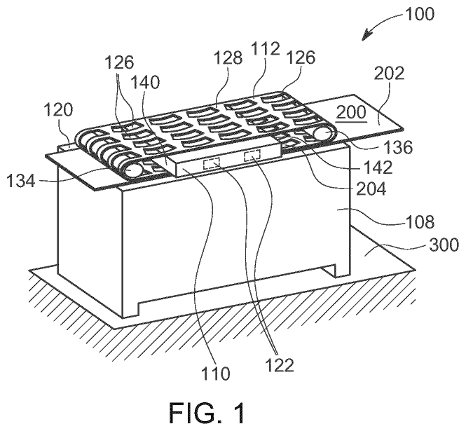

Referring to FIG. 1, an exemplary machine 100 suitable for treating a surface 200 of a film 202 is shown. In an embodiment, the film 202 may be utilised for manufacturing a sidewall blank for a container, for example, a cup. Further, the surface treatment is performed to facilitate a printing of graphics on the surface 200 of the film 202. The machine 100 includes a base 108, a surface treatment unit 110, and a template 112 for facilitating a surface treatment of selective areas of the film 202. The base 108 is disposed on a surface 300, for example, a ground, and supports various components and sub-assemblies, such as, the surface treatment unit 110, the template 112, etc., of the machine 100. The surface treatment unit 110 is configured to perform the surface treatment of the film 202 moving over a top surface 120 of the base 108. In an embodiment, the surface treatment unit 110 includes one or more corona discharge units 122 adapted to emit corona discharge towards the top surface 120 of the base 108. In an embodiment, the surface treatment unit 110 is disposed above and at a distance from the top surface 120. It may be appreciated that the surface treatment unit 110 may move in a vertical direction relative to the top surface 120 to vary or adjust a gap between the top surface 120 and the surface treatment unit 110. Adjustment of the gap between the top surface 120 and the surface treatment unit 110 may facilitate performing surface treatment of films of different thickness.

Further, in certain embodiments, the surface treatment unit 110 is controlled to continuously emit corona discharge to perform surface treatment of a continuously moving film 202. Alternatively, the surface treatment unit 110 may be controlled such that there is a predefined time gap between the two consecutive discharge events. In such a case, the film 202 may remain stationary during the discharge event and moves during the predefined time gap. Further, a discharge event may be defined as a continuous emission of corona discharge by the surface treatment unit 110 for a predetermined time period. The predetermined time period may be calculated based on a thickness of the film 202, a material of the film 202, and may correspond to a time duration needed to suitably treat the surface 200 of the film 202 to make the treated surface 200 suitable for printing desired graphics.

To facilitate surface treatment of a portion 204 of the film 202 on which printing is to be performed, the template 112 having at least one cut-out 126 is disposed between the surface treatment unit 110 and the film 202. In this embodiment, the template comprises multiple cut-outs uniformly arrayed along the displacement direction of the template. The cut-outs 126 are adapted to expose only a portion 204 of the surface 200 of the film 202 to the discharge emitted by the surface treatment unit 110 and thereby enable surface treatment of only the exposed portion 204 of the film 202. It may be appreciated that a vertical distance between the template 112 and the film 202 is selected so as to prevent a spreading of the discharge emitted by the surface treatment unit 110 beyond the edges of the cut-outs 126. Therefore, the template 112 is arranged relative to the film 202 such that the corona discharge emitted by the surface treatment unit 110 contacts only the portions 204 of the film 202 exposed by the cut-outs 126. In certain implementations, the template 112 is arranged between the surface treatment unit 110 and the film 202 such that the template 112 abuts/contacts the surface 200 of the film 202. In such cases, the template 112 could also facilitate in driving or moving the film 202 relative to the surface treatment unit 110.

As shown in FIG. 1, the template 112 may be an endless template sheet 128 adapted to move relative to the surface treatment unit 110. In an embodiment, the endless template sheet 128 is formed by joining two ends of a sheet to form a closed loop, enabling a continuous motion of the template 112. In certain implementation, endless template sheet 128 is formed of a flexible material suitable to withstand the discharge emitted by the surface treatment unit 110. In some embodiments, the endless template sheet 128 is formed by joining a plurality of metal plates. In such cases, the metal plates may be joined using hinges to facilitate or allow a certain degree of angular movements between the metal plates, thereby imparting a flexibility to the endless template sheet 128. As shown, the endless template sheet 128 moves linearly with a speed equal to a speed of the film 202 relative to the surface treatment unit 110. For supporting the endless template sheet 128, the machine 100 may include a pair of rollers, for example, a first roller 134 and a second roller 136, rotatably mounted to the base 108 of the machine 100. The rollers 134,136 are end rollers such that the endless template sheet 128 loops around each of the rollers 134,136. As shown, the first roller 134 is mounted proximate to a first side 140 of the surface treatment unit 110 and the second roller 136 is mounted/disposed proximate to a second side 142 of the surface treatment unit 110. In an implementation, at least one of the pair of rollers 134,136, for example, the first roller 134, may be a driver roller to facilitate a linear movement of the endless template sheet 128 relative to the surface treatment unit 110. Accordingly, the first roller 134 may be operatively connected to a drive motor (not shown) that facilitates a rotation of the first roller 134.

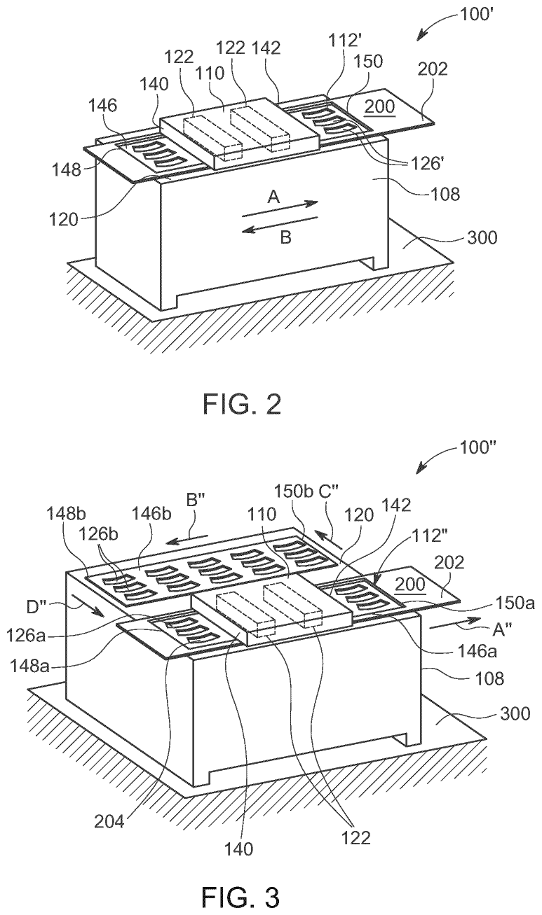

Referring to FIG. 2, a machine 100′ according to an alternative embodiment is shown. The machine 100′ is similar to the machine 100 except that a template 112′ of the machine 100′ is different from the template 112 of the machine 100. As shown, the template 112′ is a flat plate 146 or sheet having a first end 148 and a second end 150 instead of the endless template sheet 128 or loop. In an embodiment, the flat plate 146 is a made of a metal or an alloy, or any other suitable material having less wear due to the corona discharge. Similar to the template 112, the template 112′ includes at least one cut-out 126′ to expose the portion 204 of the surface 200 of the film 202 for the surface treatment. The flat plate 146 (i.e. the template 112′) is adapted to reciprocate between a first position and a second position relative to the surface treatment unit 110. It may be appreciated that the flat plate 146 moves from the first position to the second position in a first direction (i.e. direction A) corresponding to a direction of movement of the film 202 when the surface treatment is being performed, and reverses to move in a second direction (i.e. direction B) to the first position after reaching the second position. Further, a movement of the flat plate 146 is controlled such that a speed of the flat plate 146 is equal to a speed of the film 202 when the flat plate 146 moves from the first position to the second position, while the flat plate 146 moves from the second position to the first position much faster. In one embodiment, the film could slow down or even stop while the plate is moving from the second position to the first position. In another embodiment, the surface treatment unit displaces relative to the film and the template during the motion of the plate from the second to the first position.

In an implementation, in the first position, a length of a portion of the flat plate 146 is disposed on the first side 140 of the surface treatment unit 110 is greater than a length of a portion of the flat plate 146 disposed on the second side 142 of the surface treatment unit 110, while in the second position, a length of the portion of the flat plate 146 disposed on the first side 140 is smaller than a length of the portion of the flat plate 146 disposed on the second side 142. In certain scenarios, in the first position, the first end 148 is disposed away from the surface treatment unit 110, while the second end 150 is disposed beneath the surface treatment unit 110. Further, in such a scenario, in the second position, the first end 148 is disposed beneath the surface treatment unit 110 and the second end 150 is disposed away from the surface treatment unit 110. Further, it may be appreciated that the flat plate 146 includes a length that is larger than a length of the surface treatment unit 110 and typically a width greater than or equal to a width of the surface treatment portion of the surface treatmentunit 110. In certain embodiment, the template 112′ may remain stationary relative to the surface treatment unit 110 during the surface treatment of the surface of the film 202. In such a case, the film 202 is kept stationary during the surface treatment of a portion of the film 202 disposed underneath the surface treatment unit 110 and moved subsequent to the completion of the surface treatment to bring another portion of the film 202 for performing the surface treatment. Further, it may be envisioned that in such case, an operation of the surface treatment unit 110 may also be stopped or ceased during the movement of the film 202.

Referring to FIG. 3, a machine 100″ according to another embodiment is shown. The machine 100″ is similar to the machine 100′ except that a template 112″ of the machine 100″ includes a pair of plates 146a, 146b instead of a single flat plate. Each of the pair of plates 146a, 146b is adapted to move between a first position and a second position. Further, the plates 146a, 146b are disposed substantially parallel and laterally offset from each other. It may be appreciated that the each of the plates 146a, 146b, for example, a first plate 146a and a second plate 146b, is similar in construction and structure to that of the flat plate 146 and, respectively includes at least one cut-out 126a, and at least one cut-out 126b.

Further, during surface treatment of the surface 200 of the film 202, one of the pair of plates 146a, 146b, for example, the first plate 146a, moves in a first direction (i.e. in a direction A″) corresponding to a direction of the movement of the film 202, while the other of the pair of plates 146a, 146b, for example, the second plate 146b, moves in a second direction (i.e. in a direction B″) opposite to the direction of movement of the film 202.

Accordingly, the first plate 146a moves in the direction A″ to reach the second position from the first position for facilitating the surface treatment of the portions 204 of the film 202 exposed by the cut-outs 126a, while the second plate 146b moves in the direction B″ to reach the first position from the second position. After reaching the second position, the first plate 146a may be moved in a direction (i.e. direction C″) perpendicular to the direction A″ and then moves in the direction B″ to reach the first position from the second position. Similarly, the second plate 146b may be moved in a direction, i.e. a direction D″, substantially perpendicular to the direction B″ after reaching the first position to position the second plate 146b directly above the film 202. Subsequently, the second plate 146b is moved in the first direction A″ to facilitate surface treatment of the portion 204 of the film 202 exposed by the cut-outs 126b. In this manner, the pair of plates 146a, 146b are moved to facilitate a continuous surface treatment at least a portion 204 of the surface 200 of the film 202. Also, one of the pair of the plates 146a, 146b is adapted to reach the second position when the other of the pair of plates 146a, 146b reaches the first position.

In an implementation, in the first position, a length of a portion of the first plate 146a or the second plate 146b disposed on the first side 140 of the surface treatment unit 110 is greater than a length of a portion of the first plate 146a or the second plate 146b disposed on the second side 142 of the surface treatment unit 110. Moreover, in the second position, a length of the portion of the second plate 146b or the first plate 146a disposed on the first side 140 is smaller than a length of the portion of the second plate 146b or the first plate 146a disposed on the second side 142. In certain scenarios, in the first position, respective first ends 148a, 148b are disposed away from the surface treatment unit 110, while the respective second ends 150a, 150b are disposed beneath the surface treatment unit 110. Further, it may be appreciated that each of the pair of plates 146a, 146b includes a length that is larger than a length of the surface treatment unit 110 and typically a width greater than or equal to a width of the surface treatment portion of the surface treatment unit 110.

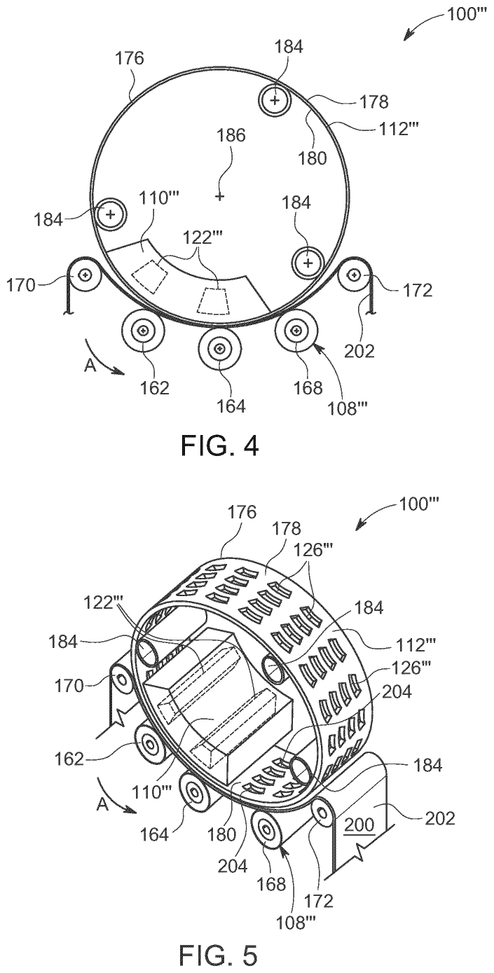

Referring to FIG. 4 and FIG. 5, a machine 100′″ according to a yet another embodiment is disclosed. The machine 100′″ includes a base 108′″ having at least one rolling unit, such as, a first rolling unit 162, a second rolling unit 164, and a third rolling unit 168, and two end rollers, for example, a first end roller 170 and a second end roller 172, for supporting the film 202 and facilitating a linear movement of the film 202. In an embodiment, the rolling units 162, 164, 168 are idler rolling units, while at least one of the two end rollers 170, 172 is a drive roller for moving the film in a direction ‘A’. The rolling units 162, 164, 168 and the end rollers 170, 172 may be rotatable mounted to a frame (not shown) of the base 108′″. Further, the machine 100′″ includes a template 112′″ in the form of a hollow roll 176 that is disposed opposite to the rolling units 162, 164, 168 such that the film 202 passes between the hollow roll 176 and the rolling units 162, 164, 168 . The film abuts an outer surface 178 of the hollow roll 176 and the rolling units 162, 164, 168. The hollow roll 176 includes at least one cut-out 126′″ extending from an inner surface 180 of the hollow roll 176 to the outer surface 178 exposing the portion 204 of the film 202 for surface treatment. To facilitate the surface treatment of the film 202, the machine 100′″ includes a surface treatment unit 110′″ disposed inside the hollow roll 176. The surface treatment unit 110′″ may be similar to the surface treatment unit 110 of the machine 100 and may include one or more corona discharge unit 122′″ to emit corona discharge for performing surface treatment of the portion 204 of the film 202. In an embodiment, the surface treatment unit 110′″ may include a shape of an arc to conform to the inner surface 180 of the hollow roll 176.

The hollow roll 176 is adapted to rotate such that a linear speed of the outer surface 178 is equal to the linear speed of the film 202. In an embodiment, the machine 100′″ may include a plurality of support rollers 184 disposed inside the hollow roll 176 abutting and supporting the hollow roll 176. In an embodiment, at least one of the support rollers 184 may be a driver roller that rotates the hollow roll 176 about a central axis 186 of the hollow roll 176. In such a case, the hollow roll 176 is formed by disposing or wrapping a sheet having the appropriate cut-outs 126′″ in a cylindrical shape around the support rollers 184 such that the support rollers 184 contact the inner surface 180 of the hollow roll 176. In such a case, the hollow roll 176 may be replaced easily. In an embodiment, the film 202 moves relative to the surface treatment unit 110′″ due to the rotation of the hollow roll 176. In such a case, the hollow roll 176 acts as a driving unit facilitating the movement of the film 202 during the surface treatment.

A surface treatment operation of the film 202 using the machine 100 is described now. Although the surface treatment operation of the film 202 using the machine 100 is described, it may be appreciated that the machine 100′, the machine 100″, and the machine 100′″ may similarly be utilized for performing the surface treatment of the film 202. For performing the surface treatment of the film 202, the film 202 is fed to the machine 100, such that the film 202 moves below the template 112 and a portion of the template 112 is disposed between the surface treatment unit 110 and the film 202. Prior to feeding the film 202, the template 112 having the cut-outs 126 with suitable shape and dimensions is mounted to the machine 100. Thereafter, the surface treatment unit 110, is switched on, enabling the emission of corona discharge towards the film 202. The corona discharge, thus emitted, passes through the various cut-outs 126 of the template 112, and treats the one or more portions 204 or areas/regions of the surface 200 of the film 202 exposed by the cut-outs 126, while the remaining areas or portions (i.e. area/regions of the surface 200 of the film 202 covered by the template 112) remains untreated. In this manner, only the selected portions 204 of the film 202 on which printing is to be performed are surface treated, while leaving other regions untreated. Accordingly, sidewall blank of a container formed by the treated film can be easily welded to a bottom blank, facilitating a manufacturing of the container, such as the cup. For example, the portion of the sidewall blank which forms the side seal and/or the portion of the sidewall blank which forms the bottom seal, could remain untreated, while the non welded portion of the blank can be treated to allow printing directly on the treated surface.

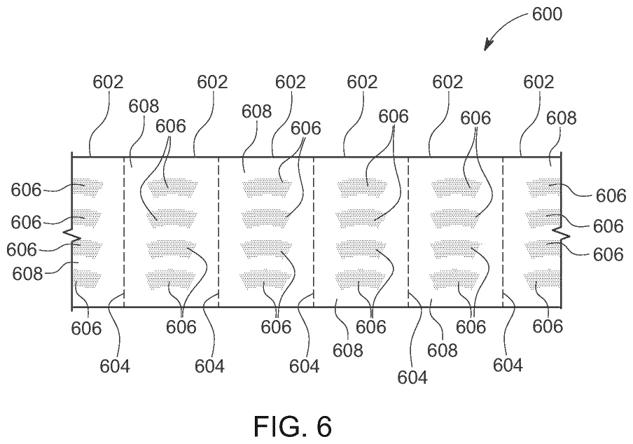

Referring to FIG. 6, an exemplary surface treated film 600 from which a plurality of sidewall blanks 602 will be cut is shown in FIG. 6. The surface treated film 600 is obtained by performing the surface treatment of the film 202 using the machine 100, 100′, 100″, 100′″. It may be envisioned that the sidewall blanks 602 are obtained by cutting the film 600 along lines 604. As shown, each sidewall blank 602 includes the portions 606 treated by the surface treatment unit 110, 110′″, and untreated area/portion/region 608. Therefore, each sidewall blank 602 has the untreated portion 608 along its edges. Accordingly, the sidewall blank 602 formed by the treated film 600 can be easily welded to a bottom blank, facilitating a manufacturing of the container, such as the cup.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiments were chosen and described in order to best explain the principles of the present disclosure and its practical application, to thereby enable others skilled in the art to best utilize the present disclosure and various embodiments with various modifications as are suited to the particular use contemplated.

### LIST OF ELEMENTS

100 machine

100′ machine

100″ machine

100′″ machine

108 base

108′″ base

110 surface treatment unit

110′″ surface treatment unit

112 template

112′ template

112″ template

112′″ template

120 top surface

122 corona discharge unit

122′″ corona discharge unit

126 cut-out

126′ cut-out

126″ cut-out

126a cut-out

126b cut-out

126′″ cut-out

128 endless template sheet

134 first roller

136 second roller

140 first side

142 second side

146 flat plate

146a first plate

146b second plate

148 first end

148a first end

148b first end

150 second end

150a second end

150b second end

162 first rolling unit

164 second rolling unit

168 third rolling unit

170 first end roller

172 second end roller

176 hollow roll

178 outer surface

180 inner surface

184 support roller

186 central axis

200 surface

202 film

204 portion

300 surface

600 surface treated film

602 sidewall blank

604 lines

606 portions

608 untreated portion

1. A machine for surface treating a film, the machine comprising:
a surface treatment unit for surface treating at least a portion of the film; and
a template arranged between the surface treatment unit and the film and including at least one cut-out exposing the portion of the film to the surface treatment unit for performing the surface treatment,
characterized in that the machine is adapted to displace the film and the template relative to the surface treatment unit during the surface treatment of the film.

2. The machine of claim 1, wherein the template is an endless template sheet and continuously moves with the film during the surface treatment.

3. The machine of claim 2, wherein the distance between the template and the film is less than 2cm, less than 1cm or less than 0.5cm.

4. The machine of claim 1, wherein the template is a hollow roll and is adapted to rotate relative to the surface treatment unit.

5. The machine of claim 4, wherein the surface treatment unit is disposed inside the hollow roll.

6. The machine of claim 4, wherein the machine includes at least one rolling unit disposed opposite to the hollow roll such that the film is supported between the hollow roll and the at least one rolling unit.

7. The machine of claim 4, wherein the hollow roll is a driver roller facilitating the movement of the film relative to the surface treatment unit.

8. The machine of any preceding claim, wherein the surface treatment unit is a corona discharge unit or a plasma surface treatment unit.

9. The machine of any preceding claim, wherein a speed of the template relative to the surface treatment unit is equal to a speed of the film relative to the surface treatment unit.

10. The machine of claim 1, wherein the template includes a pair of plates adapted to move between a first position and a second position,
wherein one of the pair of plates moves in a first direction from the first position to the second position during the surface treatment of the film and other of the pair of plates moves in a second direction opposite to the first direction to reach the first position from the second position.
